(19) United States
(12) Patent Application Publication
(10) Pub. No.: US 2026/0278048 A1
(43) Pub. Date: Sep. 17, 2026

(54) INFORMATION PROCESSING APPARATUS, AUTHENTICATION SYSTEM, AND INFORMATION PROCESSING METHOD

(71) Applicant: Masatoshi YANASE, Kanagawa (JP)

(72) Inventor: Masatoshi YANASE, Kanagawa (JP)

(73) Assignee: Ricoh Company, Ltd., Ohta-ku, Tokyo (JP)

(21) Appl. No.: 19/167,143

(22) PCT Filed: May 7, 2024
(86) PCT No.: PCT/IB2024/054405

§ 371 Date: Sep. 19, 2025

(30) Foreign Application Priority Data
May 16, 2023 (JP) 2023-081121

(51) Int. Cl. G06F 21/31; G06F 21/60

(52) U.S. Cl. CPC G06F 21/31; G06F 21/608

(57) ABSTRACT

An information processing apparatus includes a processor and a memory. The memory stores a standard authentication application in advance and additionally stores an additional authentication application. The processor executes the additional authentication application to perform authentication of a user using a first authentication factor to generate a first authentication result. The processor executes the standard authentication application to perform authentication of the user using a second authentication factor to generate a second authentication result. The processor determines whether the user is authenticated based on the first authentication result and the second authentication result.

### TECHNICAL FIELD The present disclosure relates to an information processing apparatus, an authentication system, and an information processing method.

### BACKGROUND ART

An information processing apparatus may request a user who uses the information processing apparatus to perform an authentication operation. A manufacturer of the information processing apparatus provides an additional authentication function such as a custom authentication application as a mechanism for customers and sales companies to customize a user authentication function, separately from a standard authentication function. The customer can use the custom authentication application to employ a unique authentication method or customize a user interface.

A technique is known to enable multi-factor authentication for security enhancement (e.g., Patent Literature (PTL) 1). For example, PTL 1 discloses a technique for installing an additional application to implement multi-factor authentication.

### CITATION LIST

### Patent Literature

### PTL 1

Japanese Unexamined Patent Application Publication No. 2017-167621

### SUMMARY OF INVENTION

### Technical Problem

In such a known technique, however, it has been difficult to implement multi-factor authentication without modifying an additional authentication function that has been installed into the information processing apparatus. In other words, in order to implement the multi-factor authentication in the information processing apparatus in which a custom authentication application has already been installed, it is required to modify the existing custom authentication application.

In light of the above-described problem, one or more embodiments of the present disclosure provides a technique for implementing multi-factor authentication without modifying an additional authentication function that has already been installed.

### Solution to Problem

Specifically, one or more embodiments of the present disclosure provide an information processing apparatus including a standard authentication function provided in advance and an additional authentication function. The standard authentication function authenticates a user based on an authentication result obtained by the additional authentication function using a first authentication factor and an authentication result obtained by the standard authentication function using a second authentication factor.

An information processing apparatus according to an embodiment of the present disclosure include a standard authentication function that is provided in advance and an additional authentication function. The standard authentication function authenticates a user based on a plurality of authentication results using different authentication factors by a plurality of the additional authentication functions.

### Advantageous Effects of Invention

According to one or more embodiments of the present disclosure, multi-factor authentication is performed without modifying additional authentication functions that have already been installed.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating a comparative example of a processing flow of custom authentication performed by a custom authentication application.

FIG. 2 is a diagram illustrating a processing flow of an authentication method for performing multi-factor authentication using a custom authentication application.

FIG. 3 is a diagram illustrating a configuration of an authentication system.

FIG. 4 is a diagram illustrating a hardware configuration of an image forming apparatus.

FIG. 5 is a block diagram illustrating a functional configuration of an image forming apparatus.

FIG. 6 is a sequence diagram of a process or an operation in which an image forming apparatus performs user authentication.

FIG. 7 is a diagram illustrating an authentication factor selection screen displayed by an image forming apparatus.

FIG. 8 is a flowchart for determining authentication performed by a standard authentication application in accordance with an authentication factor selected on the authentication factor selection screen.

FIG. 9 is a block diagram illustrating a functional configuration of an image forming apparatus.

FIG. 10 is a diagram illustrating a flow of authentication processing when two custom authentication applications are enabled.

FIG. 11 is a sequence diagram of a process or an operation in which an image forming apparatus uses two custom authentication applications to perform user authentication.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an information processing apparatus and an information processing method performed by the information processing apparatus according to an embodiment of the present disclosure.

### First Embodiment

An image forming apparatus according to the present embodiment operates according to a standard authentication application that provides a standard function of authentication, and a custom authentication application. When the image forming apparatus performs user authentication, the image forming apparatus executes, in addition to the standard authentication application, the custom authentication application for allowing a user to customize an authentication factor (e.g., login information used for authentication) to implement multi-factor authentication. When the custom authentication application is not installed, the standard authentication application can perform the user authentication with a standard authentication factor (single-factor authentication).

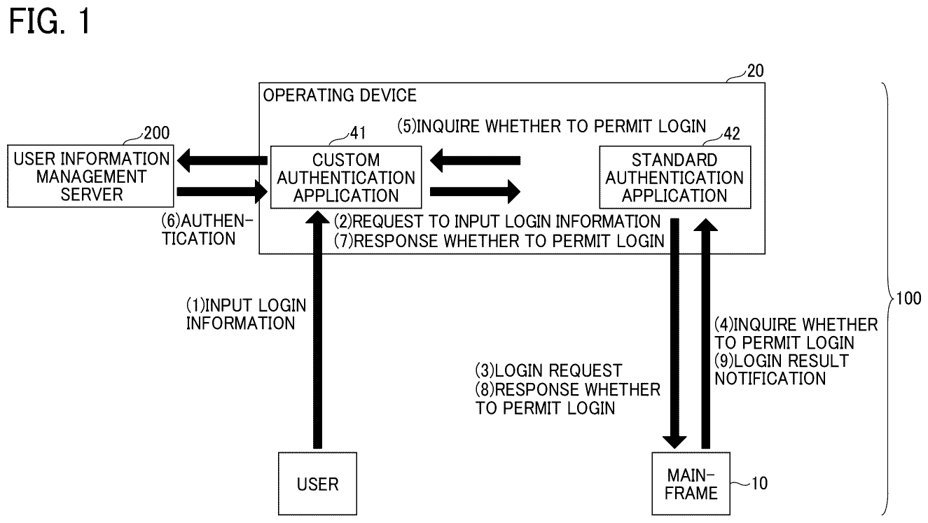

A description is given below of operations of a custom authentication application and a standard authentication application to be compared with the present embodiment with reference to FIG. 1. FIG. 1 is a diagram illustrating a comparative example of a processing flow of the custom authentication performed by a custom authentication application 41. An image forming apparatus 100 includes an operating device 20 (an example of a first device) and a main device 10 (an example of a second device). In particular, in this example, the main device 10 is an image forming device that performs image forming. The operating device 20 and the main device 10 are independent devices that operate under control of independent operating systems (OSes). It is assumed that a standard authentication application 42 and the custom authentication application 41 are installed in the operating device 20. A description is given below along steps in FIG. 1.

(1) The user inputs login information to the custom authentication application 41. The login information is an example of a first authentication factor of the user, and is, for example, a user ID and a password, biometric authentication information, or a card number of an integrated circuit (IC) card.

(2) The custom authentication application 41 sends a login request to the standard authentication application 42 together with the login information. In this example, the standard authentication application 42 communicates with the main device 10 to request for authentication for the custom authentication application 41. In this way, the standard authentication application 42 receives the login information and requests the main device 10 to log in in either case of when the custom authentication application 41 is enabled or not enabled.

(3) The standard authentication application 42 sends the login request to the main device 10 together with the login information. When the custom authentication application 41 is not enabled, the main device 10 manages authentication information. The main device 10 performs authentication processing such as a process to determine whether a job can be executed and executes the job for the user who has logged in. When the custom authentication application 41 is enabled, the main device 10 acquires information indicating that the user has been successfully authenticated from the standard authentication application 42 (response whether to permit login).
(4) Since the main device 10 does not manage the authentication information in this example (when the custom authentication application 41 is enabled, the user does not prepare the authentication information), the main device 10 requests the standard authentication application 42 to inquire of a user information management server 200 whether to permit login.
(5) The standard authentication application 42 requests the custom authentication application 41 to inquire whether to permit login together with the login information received from the custom authentication application 41.
(6) The custom authentication application 41 requests the user information management server 200 to perform user authentication together with the login information input by the user. The custom authentication application 41 may internally perform the user authentication.
(7) The custom authentication application 41 sends the response of whether to permit login (authentication success or authentication failure) acquired from the user information management server 200 to the standard authentication application 42.
(8) The standard authentication application 42 sends the response of whether to permit login to the main device 10.
(9) When the response of whether to permit login indicates that the user authentication is successful, the main device 10 sends a login result notification indicating that the login is permitted to the standard authentication application 42. After step (9), the operating device 20 can request the main device 10 to execute a job using the login result notification.

As described above, in the comparative example, the standard authentication application 42 mediates the information and the requests or responses to be used for authentication between the main device 10 and the custom authentication application 41. In the present embodiment, the multi-factor authentication using the custom authentication application 41 is implemented as follows without modifying the processing flow executed between the custom authentication application 41 and the standard authentication application 42.

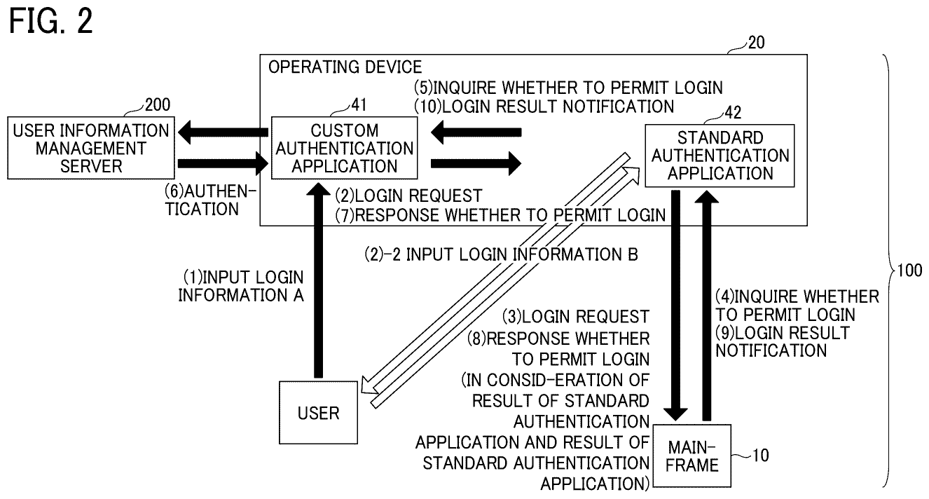

FIG. 2 is a diagram illustrating a processing flow of an authentication method for performing multi-factor authentication using the custom authentication application 41, according to the present embodiment. The description given in reference to FIG. 2 below mainly focuses the differences from FIG. 1.

(2)-2 In the present embodiment, the standard authentication application 42 interrupts the login request from the custom authentication application 41 and displays another login screen different from a screen of the custom authentication application 41 on an operation panel.

The standard authentication application 42 performs login processing using login information (an example of a second authentication factor) input to the other login screen.

(7) The custom authentication application 41 notifies the standard authentication application 42 of the response of whether to permit login from the user information management server 200.

(8) The standard authentication application 42 takes into consideration of the result of the standard authentication application 42 in the response of whether to permit login from the custom authentication application 41 to notify the response of whether to permit login to the main device 10. In other words, when the authentication using the login information input to the other login screen is successful and the login result notification indicates that the login is permitted, the standard authentication application 42 sends the response indicating that the user can log in (authentication success) to the main device 10. As a result, similarly to the comparative example of FIG. 1, the main device 10 sends the login result notification indicating that the login is permitted to the standard authentication application 42 at step (9). After step (9), the operating device 20 can request the main device 10 to execute a job using the login result notification.

In the process of FIG. 2, the custom authentication application 41 does not need to be modified, and the custom authentication application 41 sends the login request to the standard authentication application 42 in a substantially similar manner as the process in FIG. 1. The standard authentication application 42 requests the input of the login information different from the custom authentication application 41 and performs the user authentication. As a result, the standard authentication application 42 can implement the multi-factor authentication without modifying the custom authentication application 41.

Since the standard authentication application 42 performs the multi-factor authentication based on the authentication result by the custom authentication application 41, the standard authentication application 42 can control the processing flow of the user authentication in the same manner as in the case where the standard authentication application 42 performs alone the user authentication. Since the standard authentication application 42 can perform authentication alone, the standard authentication application 42 can implement the multi-factor authentication together with the authentication result of the custom authentication application 41 in a case where the custom authentication application 41 is enabled. Even if the standard authentication application 42 needs to be modified, the degree of modification can be reduced.

Authentication refers to determining whether the user is a legitimate authorized person. The login information is information that is input, for example, to the image forming apparatus by the user at the time of authentication and is used by the image forming apparatus to authenticate the user. Examples of the login information include a card number of an IC card and biometric authentication information such as a fingerprint or an iris, in addition to a user ID and a password. Information held in advance to be compared with the login information is referred to as authentication information. The login information and the authentication information have the same information.

The standard authentication function is an authentication function that is provided in, for example, the image forming apparatus that is an example of an information processing apparatus in advance. The standard authentication function authenticates the user based on login information set in advance. In the present embodiment, the information processing apparatus implements the standard authentication function with execution of a standard authentication application.

An additional authentication function is an authentication function that allows customization of the login information (authentication factor). The user can determine whether the user uses the additional authentication function. In addition to the login information, the user can customize a user interface. In the present embodiment, the information processing apparatus implements the additional authentication function with execution of a custom authentication application.

The multi-factor authentication refers to performing a plurality of user authentications for the same user using different login information. For example, the multi-factor authentication corresponds to user authentication using two or more items of login information, i.e., a card number of an IC card and biometric authentication information, in addition to a user ID and a password.

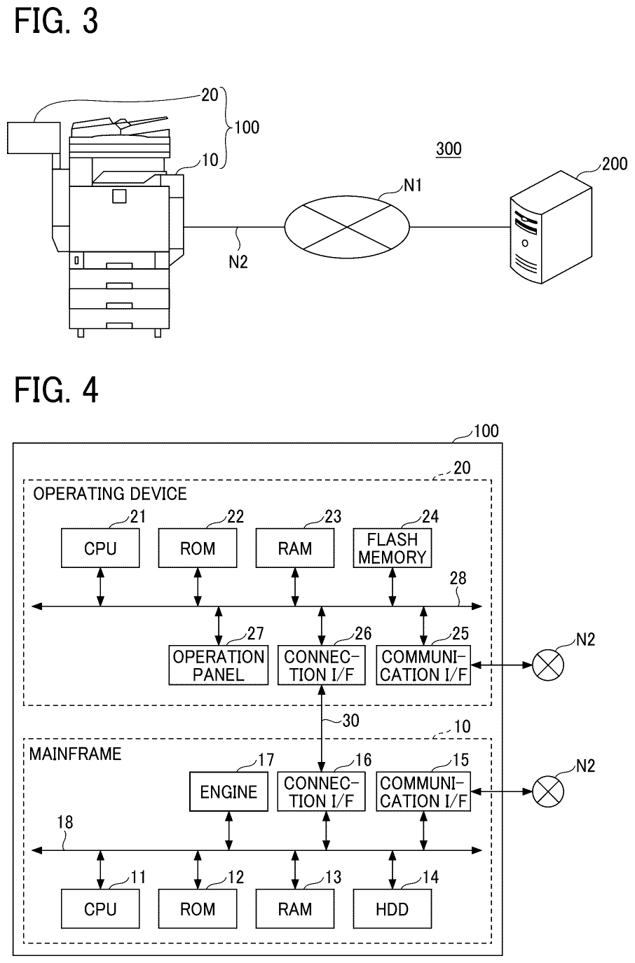

FIG. 3 is a diagram illustrating a configuration of an authentication system 300. The authentication system 300 includes the image forming apparatus 100 and the user information management server 200. The user information management server 200 and the image forming apparatus 100 are connected to each other to communicate with each other via a wide area network N1 such as the Internet. The image forming apparatus 100 is installed in a facility such as a company and is connected to a network N2 installed in the facility. The network N2 may be a local area network, a Wi-Fi® network, a wide-area ethernet®, etc. When the image forming apparatus 100 includes another type of the second device that is a mobile apparatus, the network N2 may be a cellular network such as 4G, 5G, or 6G.

The user information management server 200 is a server that manages user information and performs user authentication. The user information management server 200 may be implemented by one or more computers. The user information management server 200 may be implemented by cloud computing. Alternatively, the user information management server 200 may be implemented by a single information processing apparatus such as a computer. The “cloud computing” refers to a usage pattern in which resources on a network are used or accessed without identifying specific hardware resources. The user information management server 200 may reside on the Internet. Alternatively, the user information management server 200 may reside in an on-premises environment.

The image forming apparatus 100 may have one or more of a scanner function, a facsimile function, a print function, and a copy function, which are used by a user. The image forming apparatus 100 may be, for example, an apparatus having a plurality of different functions, such as a multifunction peripheral (MFP). The image forming apparatus 100 may be referred to as an image processing apparatus, a printing apparatus, a printer, or a scanner apparatus. A user who uses the image forming apparatus 100 may be requested to log in. In the present embodiment, the image forming apparatus 100 is described as an example. However, an information processing apparatus according to the present disclosure may be any information processing apparatus that a user logs in to and uses.

In addition to the image forming apparatus 100, the information processing apparatus may be implemented by a projector, an interactive whiteboard (IWB; an electronic whiteboard having mutual communication capability), digital signage, a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

FIG. 4 is a diagram illustrating a hardware configuration of the image forming apparatus 100. As illustrated in FIG. 4, the image forming apparatus 100 includes the main device 10 and the operating device 20. The main device 10 and the operating device 20 can communicate with each other.

The main device 10 can perform an operation in accordance with an operation received by the operating device 20. The main device 10 can also communicate with an external device such as a client PC and can perform an operation in accordance with an instruction received from the external device.

A description is given below of a hardware configuration of the main device 10. As illustrated in FIG. 4, the main device 10 includes a central processing unit (CPU) 11, a read-only memory (ROM) 12, a random-access memory (RAM) 13, a hard disk drive (HDD) 14, a communication interface (I/F) 15, a connection I/F 16, and an engine 17, which are connected to each other via a system bus 18. For convenience of description, in FIG. 4, the configuration in which the main device 10 has the HDD 14 is described as an example. However, for example, the configuration of the main device 10 may not include the HDD 14 if a sufficient storage area is not necessary.

The CPU 11 controls the overall operation of the main device 10. The CPU 11 executes programs stored in the ROM 12 or the HDD 14, using the RAM 13 as a work area to control the overall operations of the main device 10 and implement various functions, such as copying, scanning, facsimile communication, and printing.

The communication I/F 15 is an interface circuit for connecting the main device 10 to the network N2. The connection I/F 16 is an interface circuit for communicating with the operating device 20 via a communication line 30. When the communication I/F 15 employees, for example, a universal serial bus (USB), communication and charging can be performed with one cable.

The engine 17 is hardware that performs general-purpose information processing and processing other than communication for implementing the copy function, the scanner function, the facsimile function, and the print function. The engine 17 includes, for example, a scanner that scans and reads an image of an original document, a plotter (image forming unit) that performs printing on a sheet material such as a sheet of paper, and a facsimile that performs facsimile communication. The image forming apparatus 100 may further include an optional device such as a finisher that sorts printed sheet materials or an automatic document feeder (ADF) that automatically feeds an original document. A method of image forming may be an electrophotographic method or an inkjet method.

A description is given below of a hardware configuration of the operating device 20. As illustrated in FIG. 4, the operating device 20 includes a CPU 21, a ROM 22, a RAM 23, a flash memory 24, a communication I/F 25, a connection I/F 26, and an operation panel 27, which are connected to each other via a system bus 28. These components have the same or substantially the same functions as those of the main device 10. Even if these components have the different functions from those of the main device 10, a description of the present embodiment is given under the assumption that such differences are insignificant.

The operation panel 27 is a flat panel display such as a liquid crystal display or an organic electro-luminescence display, and preferably includes a touch panel integrated with the display. The operation panel 27 is used as a display device and an input device. The operation panel 27 displays soft keys and receives pressing of the soft keys. The operation panel 27 may include hard keys.

For convenience of description, in FIG. 4, the operating device 20 has been described as including the flash memory 24. However, the operating device 20 may not include the flash memory 24.

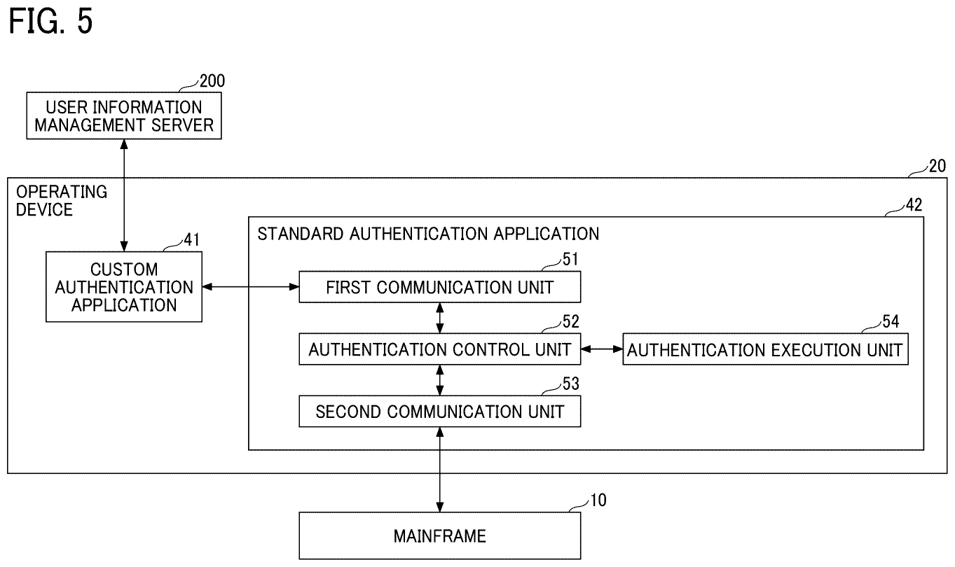

A description is given below of functions of the image forming apparatus 100 that performs multi-factor authentication with reference to FIG. 5. FIG. 5 is a block diagram illustrating a functional configuration of the image forming apparatus 100 according to an embodiment of the present disclosure.

As described above, the custom authentication application 41 and the standard authentication application 42 are operating in the operating device 20. More specifically, the CPU 21 executes processing according to the standard authentication application 42 or the custom authentication application 41, which is loaded from the ROM 22 onto the RAM 23. The standard authentication application 42 is a standard application for user authentication installed in the image forming apparatus 100 at the time of shipment (or installed by a customer engineer at the time of installation). The custom authentication application 41 is an application for user authentication provided to facilitate customization of a user authentication function. When the standard authentication application 42 performs the user authentication, the user needs to log in with predetermined login information. However, when the custom authentication application 41 performs the user authentication, a customer can employee unique login information or customize a user interface. For example, the customer can set, as the login information, a user ID and a password, biometric authentication information, or authentication using an IC card, in the custom authentication application 41.

The custom authentication application 41 can communicate with the user information management server 200 managed and operated by the customer. The user information management server 200 stores authentication information of each user of the customer, for example. When the user information management server 200 includes authentication information that matches login information sent by the custom authentication application 41, the user information management server 200 determines that the user authentication is successful. The user is verified by the successful authentication, and the operating device 20 can acquire the user ID.

The standard authentication application 42 includes a first communication unit 51, an authentication control unit 52, a second communication unit 53, and an authentication execution unit 54. These functions of the standard authentication application 42 are functions or means that are implemented by operating one or more hardware elements illustrated in FIG. 4 in cooperation with instructions of the CPU 21 according to the program loaded from the ROM 22 to the RAM 23. The standard authentication application 42 and the custom authentication application 41 may be distributed from a server for program distribution or may be distributed while being stored in a storage medium.

The first communication unit 51 communicates with the custom authentication application 41 to send and receive information required for authentication to and from the custom authentication application 41.

The authentication control unit 52 controls the processing flow of the authentication in accordance with the same procedure as in the comparative example of FIG. 1. In other words, the authentication control unit 52 controls the authentication processing in the same flow in any of the case of the authentication by the standard authentication application 42 alone, the case of the authentication by the custom authentication application 41 alone, and the case of the multi-factor authentication. The authentication control unit 52 determines whether the user authentication is successful based on all (e.g., two factors) authentication results of the multi-factor authentication. The authentication control unit 52 determines that the user authentication is successful when all authentication results are successful. However, in a case where the customer sets that the user authentication is considered successful when one authentication result alone is successful, the authentication control unit 52 may determine that the user authentication is successful when at least one of the authentication results is successful.

The second communication unit 53 communicates with the main device 10 to send and receive information required for authentication to and from the main device 10. Since the main device 10 may not be changed or may be changed to the minimum in a case of the multi-factor authentication, the second communication unit 53 sends and receives the same information as that of the comparative example to and from the main device 10.

The authentication execution unit 54 performs user authentication using login information input to a login screen displayed separately from a login screen displayed by the custom authentication application 41. The authentication execution unit 54 preferably requests the user to input login information different from the custom authentication application 41, and authenticates the user with the login information. As a result, even if the login information of the custom authentication application 41 is leaked, it would be difficult for the third party to log in to the image forming apparatus 100 unless the login information of the standard authentication application 42 is leaked, and thus security can be enhanced.

The main device 10 may or may not manage authentication information. For example, the authentication information may be included in the main device 10 or may be managed by a directory server on a network. When the authentication by the custom authentication application 41 is not enabled, the main device 10 manages the authentication information. In this case, the main device 10 performs the authentication processing. When the authentication by the custom authentication application 41 is enabled, the main device 10 does not manage the authentication information (the main device 10 does not perform the user authentication even if the authentication information is managed). In this case, since the main device 10 does not include the authentication information, the main device 10 returns an inquiry about whether to permit login in response to the login request from the standard authentication application 42.

In the present embodiment, since the case where the custom authentication application 41 is enabled is described, the main device 10 does not manage the authentication information. The standard authentication application 42 performs user authentication separately from the custom authentication application 41.

A description is given below of the flow of the authentication processing of the present embodiment illustrated in FIG. 2. A description below follows the numbers given in FIG. 2.

(1) The user inputs login information to the custom authentication application 41. The login information is, for example, a user ID and a password, biometric authentication information, or a card number of an IC card.

(2) The custom authentication application 41 sends a login request to the standard authentication application 42 together with the login information. The standard authentication application 42 performs communication for authentication with the main device 10. The standard authentication application 42 receives the login information and requests the main device 10 to log in irrespective of whether the custom authentication application 41 is enabled or not enabled.

(2)-2 When the multi-factor authentication is enabled, the standard authentication application 42 interrupts the login request from the custom authentication application 41, and displays a login screen (an example of a second login screen) different from a login screen displayed by the custom authentication application 41. The user inputs login information (e.g., a user ID and a password, biometric authentication information, or a card number of an IC card, which are examples of second login information) to the standard authentication application 42. The standard authentication application 42 authenticates the user using the input login information.

The timing at which the standard authentication application 42 authenticates the user may be any timing between a time immediately after the login information is input to the second login screen and a time after the response of whether to permit login is received from the user information management server 200. The standard authentication application 42 may perform authentication immediately after the login information is input to the second login screen, and may omit subsequent processes in a case where the authentication fails.

(3) The standard authentication application 42 sends the login request to the main device 10 together with the login information from the custom authentication application 41. When the custom authentication application 41 is not enabled, the main device 10 manages the authentication information. The main device 10 performs authentication processing such as a process to determine whether a job can be executed and executes the job for the user who has logged in. When the custom authentication application 41 is enabled, the main device 10 acquires information indicating that the user has been successfully authenticated from the standard authentication application 42 (response of whether to permit login).

(4) Since the main device 10 does not manage the authentication information (when the custom authentication application 41 is enabled, the user does not prepare the authentication information), the main device 10 requests the standard authentication application 42 to inquire of a user information management server 200 whether to permit login.

(5) The standard authentication application 42 requests the custom authentication application 41 to inquire whether to permit login together with the login information received from the custom authentication application 41.

(6) The custom authentication application 41 requests the user information management server 200 to perform user authentication together with the login information input by the user. The custom authentication application 41 may internally perform the user authentication.

(7) The custom authentication application 41 sends the response of whether to permit login (authentication success or authentication failure) acquired from the user information management server 200 to the standard authentication application 42.

(8) The standard authentication application 42 determines that the user authentication to the image forming apparatus 100 has succeeded when both the authentication result included in the response of whether to permit login and the authentication result of the standard authentication application 42 indicate that the authentication succeeded. More specifically, when the user ID included in the response of whether to permit login matches the user ID authenticated by the standard authentication application 42 (when the user is determined to be the same user), the standard authentication application 42 determines that the user authentication to the image forming apparatus 100 has succeeded. The standard authentication application 42 sends the response of whether to permit login including authentication success or authentication failure to the main device 10.

(9) When the response of whether to permit login indicates that the user authentication is successful, the main device 10 sends a login result notification indicating that the login is permitted to the standard authentication application 42. After step (9), the operating device 20 can request the main device 10 to execute a job using the login result notification.

(10) The standard authentication application 42 notifies the custom authentication application 41 of the login result in order to notify the final authentication result.

As described above, since the standard authentication application 42 performs the user authentication using the second factor without changing the existing interfaces between the standard authentication application 42 and the custom authentication application 41 and between the standard authentication application 42 and the main device 10, the multi-factor authentication can be implemented without modifying the existing custom authentication application 41.

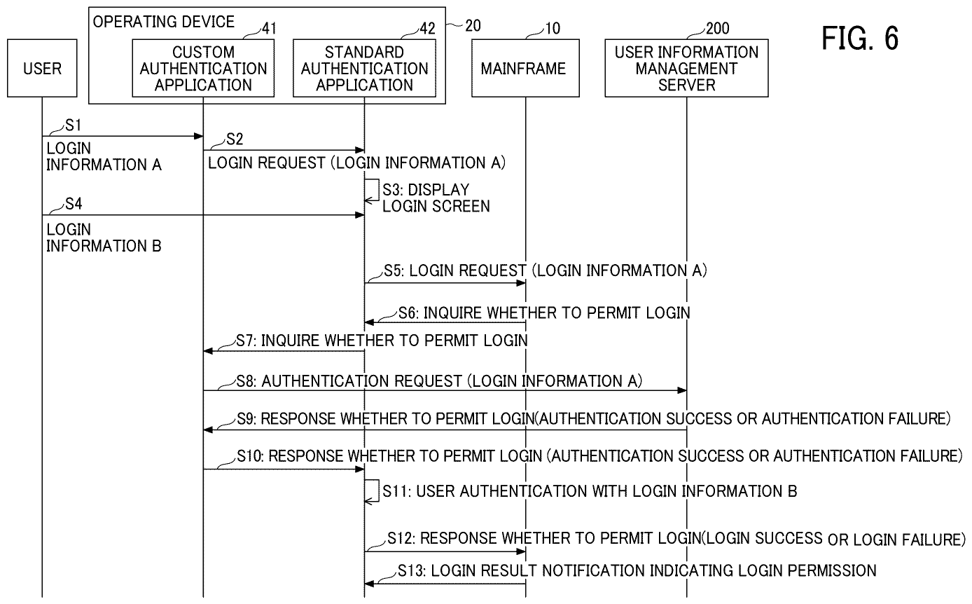

FIG. 6 is a sequence diagram of a process or an operation in which the image forming apparatus 100 performs user authentication. A description below of FIG. 6 overlaps with the description of FIG. 2, as they describe the same processes.

In step S1, which corresponds to (1), the custom authentication application 41 displays the login screen generated by the custom authentication application 41. The user inputs login information to the custom authentication application 41. In the following description, the login information input to the custom authentication application 41 is referred to as login information A.

In step S2, which corresponds to (2), the custom authentication application 41 sends a login request to the standard authentication application 42 together with the login information A. The transmission of the login information A from the custom authentication application 41 to the standard authentication application 42 is set in the custom authentication application 41 in advance for the consistency of the process.

In step S3, which corresponds to (2)-2, the first communication unit 51 receives the login request from the custom authentication application 41. When the multi-factor authentication is enabled, the authentication control unit 52 determines to display the second login screen that is different from the login screen of the custom authentication application 41 in response to the login request, and requests the authentication execution unit 54 to display the second login screen. The authentication execution unit 54 displays the second login screen, on the operation panel 27. The second login screen may be displayed after step S10.

In step S4, which corresponds to (2)-2, the user inputs login information to the standard authentication application 42. In the following description, the login information input to the standard authentication application 42 is referred to as login information B.

In step S5, which corresponds to (3), as in the comparative example, the authentication control unit 52 determines to send the login request from the custom authentication application 41 to the main device 10. The second communication unit 53 sends the login request to the main device 10 together with the login information A from the custom authentication application 41. This transmission of the login request from the second communication unit 53 to the main device 10 may be performed in parallel with the display of the second login screen.

In step S6, which corresponds to (4), the main device 10 receives the login request. However, since the main device 10 does not include the authentication information, the main device 10 requests the standard authentication application 42 to inquire of the user information management server 200 whether the login is permitted.

In step S7, which corresponds to (5), the second communication unit 53 of the standard authentication application 42 receives the inquiry about whether to permit login. In response to receiving the inquiry about whether to permit login, the authentication control unit 52 causes the first communication unit 51 to send the inquiry about whether to permit login to the custom authentication application 41 together with the login information A.

In step S8, which corresponds to (6), the custom authentication application 41 requests the user information management server 200 to perform user authentication together with the login information A input by the user. The custom authentication application 41 may internally perform the user authentication.

In step S9, the user information management server 200 determines whether the user authentication is successful or failed based on whether the user information management server 200 stores authentication information that is the same as the login information A. The user information management server 200 sends the response of whether to permit login to the custom authentication application 41. The custom authentication application 41 receives the response of whether to permit login (authentication success or authentication failure) from the user information management server 200. The custom authentication application 41 can also receive a user ID when the user authentication is successful.

In step S10, which corresponds to (7), the custom authentication application 41 sends the response of whether to permit login (authentication success or authentication failure) to the standard authentication application 42.

In step S11, which corresponds to (8), the first communication unit 51 of the standard authentication application 42 receives the response of whether to permit login (authentication success or authentication failure). When the response of whether to permit login indicates authentication success, the authentication control unit 52 causes the authentication execution unit 54 to perform user authentication using the login information B. In other words, when the authentication information set in advance includes authentication information that matches the login information B, the authentication execution unit 54 determines that the user authentication is successful. On the other hand, when the authentication information set in advance does not include authentication information that matches the login information B, the authentication execution unit 54 determines that the user authentication is failed. When the user authentication is successful, the authentication execution unit 54 specifies the user ID. The user authentication performed by the authentication execution unit 54 may be performed at any time after the login information B is received by the standard authentication application 42 in step S4.

The authentication control unit 52 determines that the user authentication to the image forming apparatus 100 has succeeded when both the user authentication result included in the response of whether to permit login and the user authentication result of the authentication execution unit 54 indicate that the authentication succeeded. More specifically, when the user ID included in the response of whether to permit login matches the user ID authenticated by the authentication execution unit 54 (when the user is determined to be the same user), the authentication control unit 52 determines that the user authentication to the image forming apparatus 100 has succeeded.

In step S12, the second communication unit 53 sends the response of whether to permit login including authentication success or authentication failure to the main device 10.

In step S13, which corresponds to (9), when the response of whether to permit login indicates that the user authentication is successful, the main device 10 sends the login result notification indicating that the login is permitted to the standard authentication application 42. After step S13, the operating device 20 can request the main device 10 to execute a job using the login result notification.

In step S11 of FIG. 6, the standard authentication application 42 performs the user authentication using the login information B after the standard authentication application 42 receives the response of whether to permit login from the user information management server 200. However, the standard authentication application 42 may perform the user authentication immediately after step S4. In this case, when the user authentication performed by the standard authentication application 42 is failed, the process may be canceled after step S5.

The standard authentication application 42 may display the second login screen after the standard authentication application 42 receives the response of whether to permit login from the user information management server 200 in step S11. In this case, when the response of whether to permit login from the user information management server 200 indicates that the user authentication is failed, the standard authentication application 42 may not display the second login screen.

In the present embodiment, the custom authentication application 41 may perform the same process as the comparative example in which the custom authentication application 41 sends the login request to the standard authentication application 42. In addition, since the standard authentication application 42 requests input of login information different from the custom authentication application 41 and performs the authentication with the different login information, the standard authentication application 42 can implement the multi-factor authentication without modifying the custom authentication application 41. Even if the standard authentication application 42 needs to be modified, the degree of modification can be reduced.

### Second Embodiment

A description is given below of the image forming apparatus 100 according to the present embodiment that allows the user to combine a plurality of custom authentication applications 41 to implement multi-factor authentication. When three or more custom authentication applications 41 are installed in the image forming apparatus 100, the user can combine any two or more of the custom authentication applications 41. The image forming apparatus 100 displays an authentication factor selection screen on which two or more custom authentication applications 41 can be selected, and performs multi-factor authentication in which any two or more of the custom authentication applications 41 selected by the user are combined.

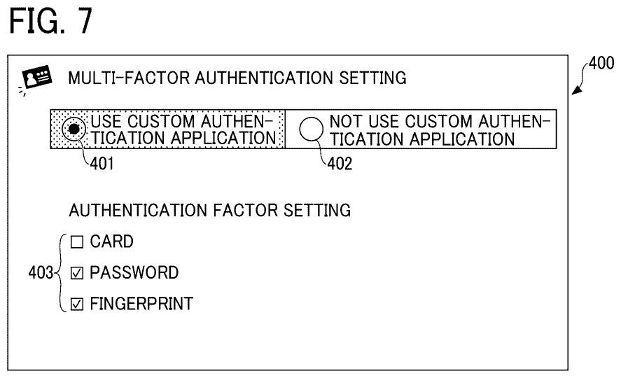

FIG. 7 is a diagram illustrating an authentication factor selection screen 400 displayed by the image forming apparatus 100. The administrator of the image forming apparatus 100 can display the authentication factor selection screen 400, and request the user to select which custom authentication application 41 is to be used. In the example of FIG. 7, the login information (an IC card, a password, and a fingerprint) and the custom authentication applications 41 are associated with each other. When the administrator selects the login information desired by the user, the custom authentication application 41 that corresponds to the selected login information is also selected.

The authentication factor selection screen 400 includes radio buttons 401 and 402 for selecting whether to use the custom authentication application 41. When the radio button 402 not using the custom authentication application 41 is selected, the user authentication by the standard authentication application 42 alone is performed (the multi-factor authentication is not performed). When the custom authentication application 41 is additionally installed, the user can select whether to perform the multi-factor authentication.

When the radio button 401 for using the custom authentication application 41 is selected, the authentication factor setting check box 403 is enabled (selected). The authentication factor setting check boxes 403 correspond to the authentication factors (the IC card, the password, and the fingerprint). The administrator checks the authentication factor setting check box 403, which is associated with the authentication factor to be set, as the login information in the multi-factor authentication.

When the administrator selects two or more authentication factors (custom authentication applications 41) using the authentication factor setting check box 403, multi-factor authentication can be performed even without authentication by the standard authentication application 42. In other words, when the administrator selects one multi-factor authentication alone, the custom authentication application 41 and the standard authentication application 42 perform the multi-factor authentication (the same as the first embodiment), and when the administrator selects two or more multi-factor authentications, the two or more custom authentication applications 41 that correspond to the selected authentications perform the multi-factor authentication.

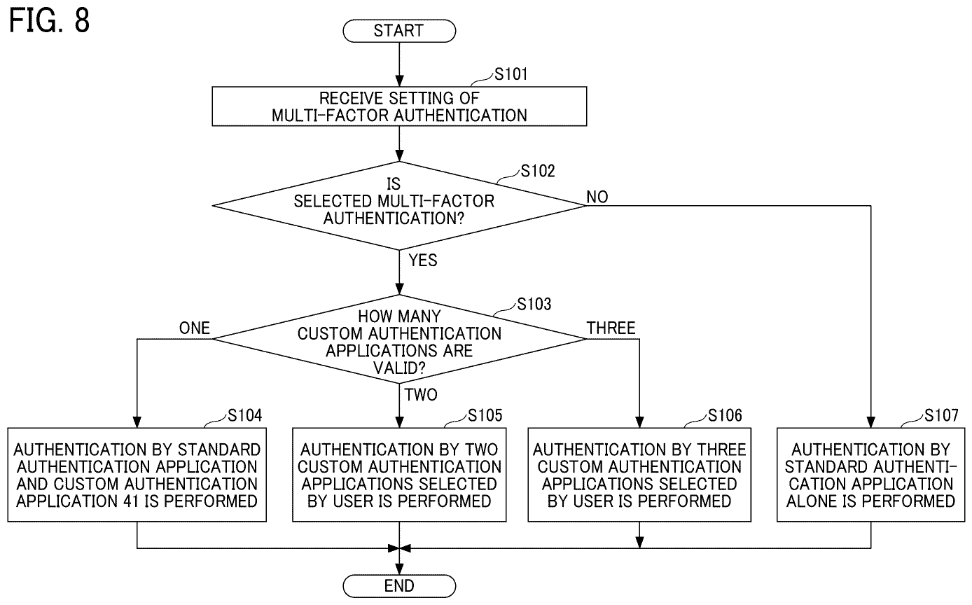

FIG. 8 is a flowchart of determining authentication performed by the standard authentication application 42 in accordance with an authentication factor selected on the authentication factor selection screen 400.

In step S101, the operation panel 27 of the image forming apparatus 100 displays the authentication factor selection screen 400 and receives setting of the multi-factor authentication.

In step S102, the authentication control unit 52 of the standard authentication application 42 determines whether the multi-factor authentication (the radio button 401 for using the custom authentication application 41) is selected.

When the radio button 401 for using the custom authentication application 41 is not selected (No in step S102), in step S107, the authentication control unit 52 determines that the user authentication is performed by the standard authentication application 42 alone.

When the radio button 401 for using the custom authentication application 41 is selected (Yes in step S102), in step S103, the authentication control unit 52 determines which authentication function is to be used in accordance with the custom authentication application 41 enabled by the selection.

When the number of the enabled custom authentication applications 41 is one, in step S104, the authentication control unit 52 determines that the standard authentication application 42 and the custom authentication application 41 perform the user authentication.

When the number of the enabled custom authentication applications 41 is two, in step S105, the authentication control unit 52 determines that the two custom authentication applications 41 selected by the user perform the user authentication.

When the number of the enabled custom authentication applications 41 is three, in step S106, the authentication control unit 52 determines that the three custom authentication applications 41 selected by the user perform the user authentication.

As described above, the image forming apparatus 100 according to the present embodiment can implement user authentication using the standard authentication application 42 alone, the user authentication using the standard authentication application 42 and the custom authentication application 41, or the user authentication using the custom authentication applications 41 without modifying the custom authentication application 41.

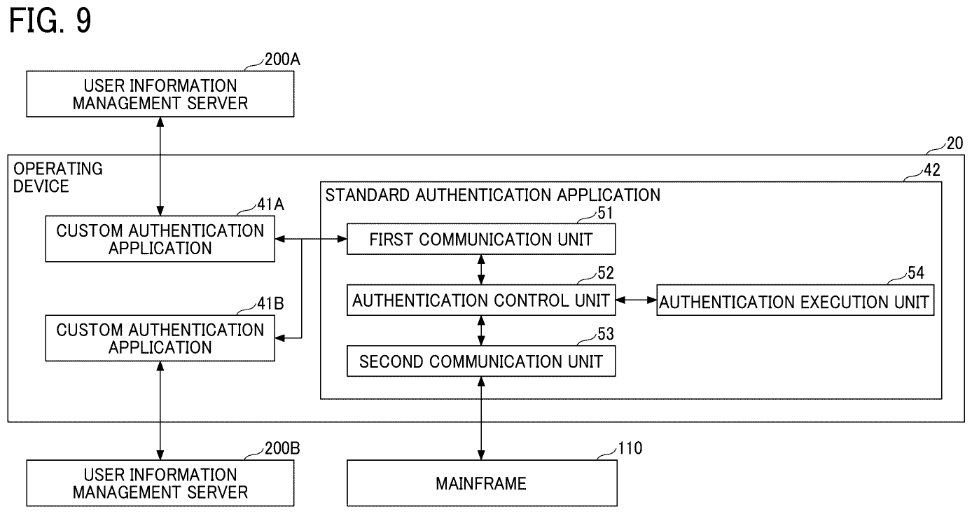

FIG. 9 is a block diagram illustrating a functional configuration of the image forming apparatus 100 according to the present embodiment. The description given in reference to FIG. 9 mainly focuses on the differences from FIG. 5.

In the operating device 20, the custom authentication applications 41A and 41B and the standard authentication application 42 are operating. Since the user has selected two custom authentication applications 41, the custom authentication applications 41A and 41B are illustrated in FIG. 9. Three or more custom authentication applications 41 may execute in the operating device 20.

The standard authentication application 42 has the same function as that of FIG. 5. However, the authentication execution unit 54 in FIG. 9 does not perform the user authentication. When two or more custom authentication applications 41 are selected, the authentication control unit 52 skips the user authentication by the authentication execution unit 54.

The custom authentication application 41A can communicate with a user information management server 200A managed and operated by the customer. The custom authentication application 41B can communicate with a user information management server 200B managed and operated by the customer. The user information management servers 200A and 200B store authentication information of each user corresponding to the custom authentication applications 41A and 41B, respectively. One of the user information management servers 200A and 200B may store the login information corresponding to the custom authentication applications 41A and 41B.

The functions of the main device 10 may be the same as those of the main device 10 in FIG. 5. When the user authentication by the custom authentication application 41 is enabled, the main device 10 does not manage the authentication information. In this case, since the main device 10 does not manage the authentication information, the main device 10 returns the inquiry about whether to permit login in response to the login request from the standard authentication application 42.

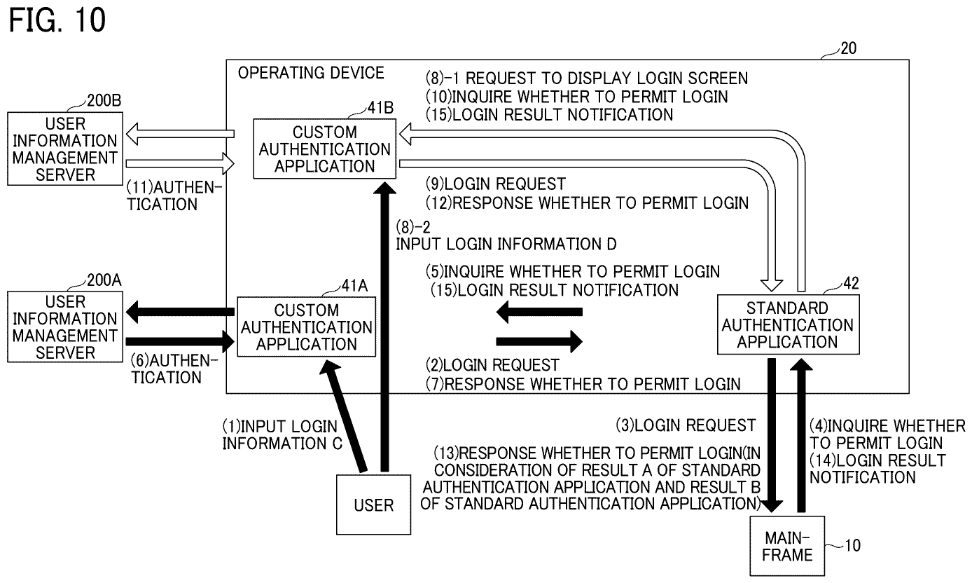

FIG. 10 is a diagram of a flow of authentication processing when the two custom authentication applications 41 are enabled. A description below follows the numbers given in FIG. 10.

(1) The user inputs login information C (a user ID and a password, biometrics information, or a card number of an IC card) to the custom authentication application 41A.

(2) The custom authentication application 41A sends the login request to the standard authentication application 42 together with the login information C. The standard authentication application 42 performs communication for authentication with the main device 10. The standard authentication application 42 receives the login information and requests the main device 10 to log in irrespective of whether the custom authentication application 41 is enabled or not enabled.

(3) The standard authentication application 42 sends the login request to the main device 10 together with the login information C from the custom authentication application 41A. When the custom authentication applications 41A and 41B are not enabled, the main device 10 manages the authentication information. The main device 10 performs authentication processing such as a process to determine whether a job can be executed and executes the job for the user who has logged in. When the custom authentication applications 41A and 41B are enabled, the main device 10 acquires information indicating that the user has been successfully authenticated from the standard authentication application 42 (response of whether to permit login).

(4) Since the main device 10 does not manage the authentication information, the main device 10 requests the standard authentication application 42 to inquire of the user information management server 200 (the main device 10 does not specify the user information management servers 200A and 200B) whether to permit login.

(5) The standard authentication application 42 requests the custom authentication application 41A to inquire whether to permit login together with the login information C received from the custom authentication application 41A.

(6) The custom authentication application 41A requests the user information management server 200A to perform user authentication together with the login information C input by the user. The custom authentication application 41A may internally perform the user authentication.

(7) The custom authentication application 41A sends a response A of whether to permit login acquired from the user information management server 200A to the standard authentication application 42.

(8)-1, (8)-2 When the setting indicates that the custom authentication application 41B is enabled, the standard authentication application 42 requests the custom authentication application 41B to display a login screen (an example of a third login screen). The user inputs login information D (e.g., a user ID and a password, biometric authentication information, or a card number of an IC card, which are examples of third login information) to the custom authentication application 41B.

(9) The custom authentication application 41B sends the login request to the standard authentication application 42 together with the login information D. The standard authentication application 42 performs communication for authentication with the main device 10. The standard authentication application 42 receives the login information and requests the main device 10 to log in when the custom authentication applications 41A and 41B are enabled or not enabled.

(10) Since the standard authentication application 42 has already received the request for the inquiry about whether to permit login from the main device 10, the standard authentication application 42 requests the custom authentication application 41B to inquire whether to permit login together with the received login information D.

(11) The custom authentication application 41B requests the user information management server 200B to perform the user authentication together with the login information D input by the user. The custom authentication application 41B may internally perform the user authentication.

(12) The custom authentication application 41B sends a response B of whether to permit login acquired from the user information management server 200B to the standard authentication application 42.

(13) The standard authentication application 42 determines that the user authentication to the image forming apparatus 100 has succeeded when both the authentication result included in the response A of whether to permit login and the authentication result included in the response B of whether to permit login indicate that the authentications have succeeded. More specifically, when the user ID included in the response A of whether to permit login and the user ID included in the response B of whether to permit login match (when the user is determined to be the same user), the standard authentication application 42 determines that the user authentication to the image forming apparatus 100 has succeeded. The standard authentication application 42 sends the response of whether to permit login including authentication success or authentication failure to the main device 10.

(14) When the response of whether to permit login indicates that the user authentication is successful, the main device 10 sends the login result notification indicating that the login is permitted to the standard authentication application 42. After step (9), the operating device 20 can request the main device 10 to execute a job using the login result notification.

(15) The standard authentication application 42 notifies the custom authentication applications 41A and 41B of the login result in order to notify the final authentication result.

As described above, even when the operating device 20 includes the plurality of custom authentication applications 41, the standard authentication application 42 performs the user authentication using the second factor without changing the existing interfaces between the standard authentication application 42 and the custom authentication application 41A, between the standard authentication application 42 and the custom authentication application 41B, and between the standard authentication application 42 and the main device 10. Thus, the multi-factor authentication can be implemented without modifying the existing custom authentication applications 41A and 41B.

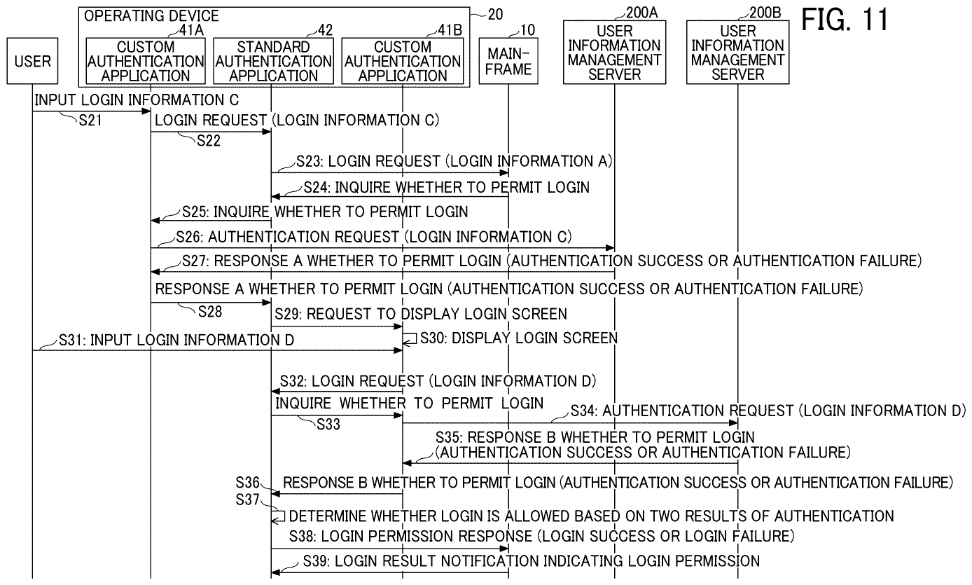

FIG. 11 is a sequence diagram of a process or an operation in which the image forming apparatus 100 uses two custom authentication applications 41A and 41B to perform user authentication. A description below of FIG. 11 partly overlaps with the description of FIG. 10, as they describe the same processes.

In step S21, the custom authentication application 41A displays a login screen generated by the custom authentication application 41A. The user inputs login information to the custom authentication application 41A. In the following description, the login information input to the custom authentication application 41A is referred to as login information C.

In step S22, the custom authentication application 41A sends a login request to the standard authentication application 42 together with the login information C. The transmission of the login information C from the custom authentication application 41A to the standard authentication application 42 is set in the custom authentication application 41 in advance for the consistency of the process.

In step S23, the first communication unit 51 receives the login request from the custom authentication application 41A. Since the two custom authentication applications are enabled, the authentication control unit 52 does not display the second login screen. The authentication control unit 52 causes the second communication unit 53 to send the login request specifying login information to the main device 10, as in the procedure of the comparative example.

In step S24, when the custom authentication applications 41A and 41B are not enabled, the main device 10 manages the authentication information. In the present embodiment, however, the main device 10 does not have the authentication information, and thus the main device 10 requests the standard authentication application 42 to inquire of the user information management server (the main device 10 does not specify the user information management servers 200A and 200B) whether to permit login.

In step S25, the second communication unit 53 of the standard authentication application 42 receives the inquiry about whether to permit login. In response to receiving the inquiry about whether to permit login, the authentication control unit 52 causes the first communication unit 51 to send the inquiry about whether to permit login to the custom authentication application 41A together with the login information C.

In step S26, the custom authentication application 41A requests the user information management server 200A to perform user authentication together with the login information C input by the user. The custom authentication application 41A may internally perform the user authentication.

In step S27, the user information management server 200A determines whether the user authentication is successful or failed based on whether the user information management server 200A stores authentication information that is the same as the login information C. The custom authentication application 41A receives the response A of whether to permit login (authentication success or authentication failure) from the user information management server 200A. The custom authentication application 41A can also receive the user ID when the user authentication is successful.

In step S28, the custom authentication application 41A sends the response A of whether to permit login (authentication success or authentication failure) to the standard authentication application 42.

In step S29, the first communication unit 51 of the standard authentication application 42 receives the response A of whether to permit login (authentication success or authentication failure). In the case of complying the same procedure as in the comparative example, the authentication control unit 52 sends the login request to the main device 10. However, the inquiry about whether to permit login has been already received from the main device 10.

Since the user also has enabled the custom authentication application 41B, the authentication control unit 52 causes the custom authentication application 41B to display the third login screen.

In step S30, the custom authentication application 41B displays a login screen generated by the custom authentication application 41B.

In step S31, the user inputs login information to the custom authentication application 41B. In the following description, the login information input to the custom authentication application 41B is referred to as login information D.

In step S32, the custom authentication application 41B sends the login request to the standard authentication application 42 together with the login information D. The transmission of the login information D from the custom authentication application 41B to the standard authentication application 42 is set in the custom authentication application 41B in advance for the consistency of the process.

In step S33, the first communication unit 51 receives the login request from the custom authentication application 41B. Since the authentication control unit 52 has already received the inquiry about whether to permit login from the main device 10, the authentication control unit 52 causes the first communication unit 51 to send the inquiry about whether to permit login to the custom authentication application 41B together with the login information D in response to receiving the login request.

In step S34, the custom authentication application 41B requests the user information management server 200B to perform the user authentication together with the login information D input by the user. The custom authentication application 41B may internally perform the user authentication.

In step S35, the user information management server 200B determines whether the user authentication is successful or failed based on whether the user information management server 200B includes authentication information that is the same as the login information D. The custom authentication application 41B receives the response B of whether to permit login (authentication success or authentication failure) from the user information management server 200B. The custom authentication application 41B can also receive the user ID when the user authentication is successful.

In step S36, the custom authentication application 41B sends the response B of whether to permit login (authentication success or authentication failure) to the standard authentication application 42.

In step S37, the first communication unit 51 receives the response B of whether to permit login (authentication success or authentication failure). After the authentication by the two custom authentication applications 41A and 41B is finished, the authentication control unit 52 determines that the authentication to the image forming apparatus 100 is successful when both the authentication result included in the response A of whether to permit login and the authentication result included in the response B of whether to permit login are successful. More specifically, when the user ID included in the response A of whether to permit login and the user ID included in the response B of whether to permit login match (when the user is determined to be the same user), the authentication control unit 52 determines that the user authentication to the image forming apparatus 100 has succeeded.

In step S38, the second communication unit 53 sends the response of whether to permit login including authentication success or authentication failure to the main device 10.

In step S39, when the response of whether to permit login indicates that the user authentication is successful, the main device 10 sends the login result notification indicating that the login is permitted to the standard authentication application 42. After step (9), the operating device 20 can request the main device 10 to execute a job using the login result notification.

In the present embodiment, even when a plurality of custom authentication applications 41 are enabled, the custom authentication application 41 may perform the same process as the comparative example in which the custom authentication application 41 sends the login request to the standard authentication application 42. In addition, the standard authentication application 42 can use the authentication results of the plurality of enabled custom authentication applications 41 in a comprehensive manner to determine whether to permit login. As a result, the standard authentication application 42 can implement the multi-factor authentication without modifying the custom authentication application 41.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, the operating device 20 and the main device 10 may not be separated, and the operating device 20 and the main device 10 may be included in one image forming apparatus in a form where the operating device 20 and the main device 10 cannot be separated. The operating device 20 and the main device 10 may be operated by the same OS.

The examples of configuration illustrated in, for example, FIG. 5 are divided according to main functions in order to facilitate understanding of processing by the image forming apparatus 100. The scope of the present disclosure is not limited by how the process units are divided or by the names of the process units. The processes of the image forming apparatus 100 are divided into more segmentalized process units according to the process content. One process may be divided to include the larger number of processes.

Each of the functions of the embodiments described above may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and circuit components arranged to perform the recited functions.

A description is given below of some aspects of the present disclosure.

### Aspect 1

An information processing apparatus includes a standard authentication function provided in advance and an additional authentication function. The information processing apparatus authenticates a user based on an authentication result using a first authentication factor by the additional authentication function and an authentication result using a second authentication factor by the standard authentication function, or a plurality of authentication results using different authentication factors by a plurality of additional authentication functions including the additional authentication function.

### Aspect 2

An information processing apparatus includes a standard authentication function provided in advance and a plurality of additional authentication functions. The information processing apparatus authenticates a user based on a plurality of authentication results using different authentication factors by the plurality of additional authentication functions.

### Aspect 3

In the information processing apparatus according to Aspect 1, the additional authentication function notifies the standard authentication function of an authentication result using the first authentication factor. When one additional authentication function is enabled, the standard authentication function authenticates the user based on the authentication result notified from the one additional authentication function and an authentication result based on the received second authentication factor.

### Aspect 4

The information processing apparatus according to Aspect 3 further includes a first apparatus and a second apparatus that can communicate with each other. The first apparatus performs the standard authentication function and the additional authentication function. The standard authentication function is configured to request login to the second apparatus. The additional authentication function notifies the standard authentication function of login information received from the user. The standard authentication function is configured to request login to the second apparatus using the login information. When the standard authentication function receives an inquiry about whether to permit login, the standard authentication function is configured to request the additional authentication function to perform authentication using the login information.

### Aspect 5

In the information processing apparatus according to Aspect 4, when the additional authentication function notifies the standard authentication function of the login information received from the user, the standard authentication function displays a second login screen for receiving second login information, and the information processing apparatus authenticates the user based on an authentication result obtained by the standard authentication function using the second login information and an authentication result obtained by the additional authentication function using the login information.

### Aspect 6

In the information processing apparatus according to Aspect 2, the additional authentication function notifies the standard authentication function of an authentication result obtained by the additional authentication function using a first authentication factor. When two additional authentication functions are enabled, the standard authentication function does not perform authentication and authenticates the user based on the authentication results obtained by the two additional authentication functions.

### Aspect 7

The information processing apparatus according to Aspect 6, further includes a first apparatus and a second apparatus that can communicate with each other. The first apparatus performs the standard authentication function and the two additional authentication function. The standard authentication function requests login to the second apparatus. The first additional authentication function notifies the standard authentication function of login information received from the user. The standard authentication function requests login to the second apparatus using the login information. When the standard authentication function receives an inquiry about whether to permit login, the standard authentication function requests the first additional authentication function to perform authentication using the login information.

### Aspect 8

In the information processing apparatus according to Aspect 7, when the first additional authentication function notifies the standard authentication function of an authentication result, the standard authentication function requests the second additional authentication function to display a third login screen for receiving third login information. When the third login information is received from the second additional authentication function, the standard authentication function requests the second additional authentication function to perform authentication using the third login information, and authenticates the user based on an authentication result obtained by the first additional authentication function using the login information and an authentication result obtained by the second additional authentication function using the third login information.

### Aspect 9

The information processing apparatus according to any one of Aspects 1 to 8 is set of whether to perform multi-factor authentication. When the information processing apparatus is set not to perform the multi-factor authentication, the standard authentication function alone performs user authentication.

### Aspect 10

The information processing apparatus according to Aspect 9 receives selection of an additional authentication function to be enabled among the plurality of additional authentication functions. The standard authentication function performs multi-factor authentication using the standard authentication function and the additional authentication function, or the plurality of additional authentication functions according to the selected additional authentication function.

### Aspect 11

In the information processing apparatus according to any one of Aspects 1 to 10, the additional authentication function is customized an authentication factor.

### Aspect 12

The information processing apparatus according to any one of Aspects 1 to 10 is an image forming apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

This patent application is based on and claims priority to Japanese Patent Application No. 2023-081121, filed on May 16, 2023, in the Japan Patent Office, the entire disclosure of which is hereby incorporated by reference herein.

### REFERENCE SIGNS LIST

10: main device
20: operating device
100: image forming apparatus

1. An information processing apparatus comprising:
processing circuitry; and
a memory configured to store a standard authentication application,
wherein, in response to an additional authentication application being additionally stored in the memory,
the processing circuitry is configured to
execute the additional authentication application to perform a first authentication of a user using a first authentication factor, and generate a first authentication result based on results of the first authentication,
execute the standard authentication application to perform a second authentication of the user using a second authentication factor, and generate a second authentication result based on results of the second authentication, and
determine whether the user is authenticated based on the first authentication result and the second authentication result.

2. An information processing apparatus comprising:
processing circuitry; and
a memory configured to store a standard authentication application,
wherein, in response to two or more additional authentication applications being additionally stored in the memory,
the processing circuitry is configured to
execute the two or more additional authentication applications to perform two or more authentication of a user using two or more authentication factors, and to generate two or more authentication results based on results of the two or more authentications, the two or more authentication factors being different from one another, and
determine whether the user is authenticated based on the two or more authentication results.

3. The information processing apparatus according to claim 1, wherein
the additional authentication application is configured to notify the standard authentication application of the first authentication result; and
the standard authentication application is configured to authenticate the user based on the first authentication result and the second authentication result in response to the additional authentication application being enabled.

4. The information processing apparatus according to claim 3, comprising:
a first device including the processing circuitry; and
a second device,
the first device and the second device being configured to communicate with each other, wherein
the additional authentication application is further configured to notify the standard authentication application of login information received from the user,
the standard authentication application is further configured to request the second device to login using the login information, and
in response to the standard authentication application receiving an inquiry of whether to permit login, the standard authentication application is further configured to request the additional authentication application to perform the first authentication using the login information.

5. The information processing apparatus according to claim 4, wherein the additional authentication application is further configured to receive first login information via a first login screen displayed by the additional authentication application;
the standard authentication application is further configured to receive second login information via a second login screen; and
the processing circuitry is further configured to authenticate the user based on the second login information and the first login information.

6. The information processing apparatus according to claim 2, wherein
each of the two or more additional authentication applications is configured to notify the standard authentication application of a respective authentication result; and
the proceessing circuitry is further configured to determine whether the user is authenticated based on the two or more authentication results in response to the two or more additional authentication applications being enabled.

7. The information processing apparatus according to claim 6, further comprising:
a first device including the processing circuitry; and
a second device, and
the first device and the second device being configured to communicate with each other, wherein
the processing circuitry is further configured to execute the standard authentication application, in addition to a first additional authentication application and a second additional authentication application of the two or more additional authentication applications,
the first additional authentication application is further configured to notify the standard authentication application of login information received from the user,
the standard authentication application is further configured to request the second device to log in using the login information, and
in response to the standard authentication application receiving an inquiry of whether to permit a login, the standard authentication application is further configured to request the first additional authentication application to perform a first authentication of the two or more authentications using the login information to generate a first authentication result of the two or more authentication results.

8. The information processing apparatus according to claim 7, wherein
the standard authentication application is further configured to request the second additional authentication application to receive second login information via a login screen in response to the first additional authentication application notifying the standard authentication application of the first authentication result; and
the standard authentication application is further configured to request the second additional authentication application to perform a second authentication of the two or more authentications using the second login information, and determine whether the user is authenticated based on the first authentication result and a second authentication result to generate a second authentication result of the two or more authentication results, in response to the second login information being received from the second additional authentication application.

9. The information processing apparatus according to claim 1, wherein the processing circuitry is further configured to:
receive a setting indicating whether to perform multi-factor authentication; and in response to the setting indicating not to perform the multi-factor authentication,
perform the second authentication of the user to generate the second authentication result using only the standard authentication application, and
determine whether the user is authenticated based on the second authentication result.

10. The information processing apparatus according to claim 9, wherein the processing circuitry is further configured to:
receive selection of the additional authentication application among a plurality of additional authentication applications; and
perform the multi-factor authentication using the standard authentication application and the selected additional authentication application.

11. The information processing apparatus according to claim 2, wherein the processing circuitry is further configured to:
receive selection of the two or more additional authentication applications among a plurality of additional authentication applications; and
perform multi-factor authentication using the select two or more additional authentication applications.

12. The information processing apparatus according to claim 1, wherein the additional authentication application is further configured to allow customization of the first authentication factor.

13. The information processing apparatus according to claim 4, wherein the second device is an image forming device configured to perform image forming.

14. An authentication system comprising:
the information processing apparatus of claim 1; and
a server communicably connected with the information processing apparatus, the server configured to perform authentication of the user.

15. An information processing method comprising:
storing, in a memory a standard authentication application;
storing, in the memory, an additional authentication application;
executing the additional authentication application, the executing the additional authentication application including performing a first authentication of a user using a first authentication factor, and generating a first authentication result based on results of the first authentication;
executing the standard authentication application, the executing the standard authentication application including performing a second authentication of the user using a second authentication factor, and generating a second authentication result based on results of the second authentication; and
determining whether the user is authenticated based on the first authentication result and the second authentication result.
